(19) United States
(12) Patent Application Publication
(10) Pub. No.: US 2002/0178042 A1
(43) Pub. Date: Nov. 28, 2002

(54) Manufacturing resource planning tool

(76) Inventor: Gregory Gardner, Hayward, CA (US)

Correspondence Address: SAWYER LAW GROUP LLP, P.O. Box 51418, Palo Alto, CA, 94303, US

(21) Appl. No.: 09/864,712

(22) Filed: May 23, 2001

(51) Int. Cl. G06F 17/60

(52) U.S. Cl. 705/8

(57) ABSTRACT

A method and system for manufacturing resource planning (MRP) includes: selecting a processor definition, where the processor definition comprises a transfer map, where the transfer map indicates locations of values for one or more fields in a MRP document or in a database record of a MRP parts catalog; creating a plurality of maps from the transfer map; providing source data; and creating the MRP document by processing the source data according to the plurality of maps. The processor definition defines the data configuration for the MRP document or database record. The source data are then configured according to the plurality of maps to create the MRP document or database record. Since only the transfer map is stored as part of the processor definition, the source data may change without requiring changes to the processor definition and vice versa. This is more flexible and efficient than conventional method and systems.

### FIELD OF THE INVENTION

The present invention relates to the manufacturing industry, and more particularly to planning tools in the manufacturing industry.

### BACKGROUND OF THE INVENTION

The transactions between a buyer and a supplier in the manufacturing industry is well known in the art. Typically, a buyer creates a request for quotation (RFQ), which is a request to a supplier to provide a quote for a needed item. The RFQ can include a description of the item, the quantity needed, a price, and a desired delivery date. One RFQ is created for each supplier from whom the buyer wishes a quote. Once the RFQ's have been received by the suppliers, the buyer waits for the quotes.

When a supplier receives an RFQ, the information on the RFQ may be entered into a database, if the supplier has such a database. The supplier then performs the necessary inquiries within his or her company in order to provide a quote in response to the RFQ. The supplier creates the quote, and submits it to the buyer.

When the buyer receives the quotes from the suppliers, the buyer must then perform a thorough analysis to determine which supplier from which to order each item. Comparisons of the quote terms are conducted. The buyer may negotiate with each supplier before all of the terms are agreed upon.

Once the terms have been agreed upon, the buyer creates a purchase order (PO) for each supplier, setting forth all of the terms, and submitting it to the suppliers. The POs function as binding contracts between the buyer and the suppliers. The buyer then manages the POs to ensure their proper execution, and to troubleshoot any problems which may arise. Each supplier also manages the proper execution of the PO at his or her company and communicates with the buyer on a regular basis to supply the current status. Occasionally, the supplier requests changes to the PO, in which case the buyer and supplier renegotiates the terms and executes a new PO.

In the production of some of these manufacturing resource documents, i.e., the RFQ and the PO, one onerous task facing the buyer is managing information concerning various parts and connecting them with the suppliers who may supply these parts. One approach is to manually enter each part and connect it with the supplier(s). This is extremely time consuming.

Another approach is to supply the data as a catalog. The catalog may be one of three types: a text file, an Extensible Markup Language (XML) file, or a process file. The text file contains the parts data configured with the connected suppliers but with no formatting. The XML file contains the parts data configured with the connected suppliers with some formatting. The process file contains the parts data configured according to a predetermined process.

However, with the catalog approach, when an item in the catalog or a connection to a supplier is changed, or when the process is changed, the entire catalog must be changed. This approach is inflexible.

Accordingly, there exists a need for an improved method and system for manufacturing resource planning. The present invention addresses such a need.

### SUMMARY OF THE INVENTION

A method and system for manufacturing resource planning (MRP) includes: selecting a processor definition, where the processor definition comprises a transfer map, where the transfer map indicates locations of values for one or more fields in a MRP document or in a database record of a MRP parts catalog; creating a plurality of maps from the transfer map; providing source data; and creating the MRP document by processing the source data according to the plurality of maps. The processor definition defines the data configuration for the MRP document or database record. The source data are then configured according to the plurality of maps to create the MRP document or database record. Since only the transfer map is stored as part of the processor definition, the source data may change without requiring changes to the processor definition and vice versa. This is more flexible and efficient than conventional method and systems.

### BRIEF DESCRIPTION OF THE FIGURES

FIG. 1 illustrates a preferred embodiment of a system for manufacturing resource planning in accordance with the present invention.

FIG. 2 is a flowchart illustrating a preferred embodiment of a method for manufacturing resource planning in accordance with the present invention.

FIG. 3 illustrates an example MRP administration view in accordance with the present invention.

FIG. 4 illustrates an example MRP process configuration editor view in accordance with the present invention.

FIG. 5 illustrates an example MRP parts editor view in accordance with the present invention.

FIG. 6 illustrates an example MRP Line Editor view in accordance with the present invention.

FIG. 7 illustrates an example MRP PO Results view in accordance with the present invention.

FIG. 8 illustrates an example View MRP Process view in accordance with the present invention.

### DETAILED DESCRIPTION

The present invention provides an improved method and system for manufacturing resource planning. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

The manufacturing resource planning (MRP) method and system in accordance with the present invention provides a process with a processor definition. The processor definition defines the data configuration for a MRP document. The same definition may be used to create or revise database records of a MRP parts catalog. The processor definition comprises MRP items, a transfer map, defaults and settings, and a processor type. Before processing of the source data, a plurality of maps are dynamically created from the transfer map. The source data are configured according to the plurality of maps to create the MRP document.

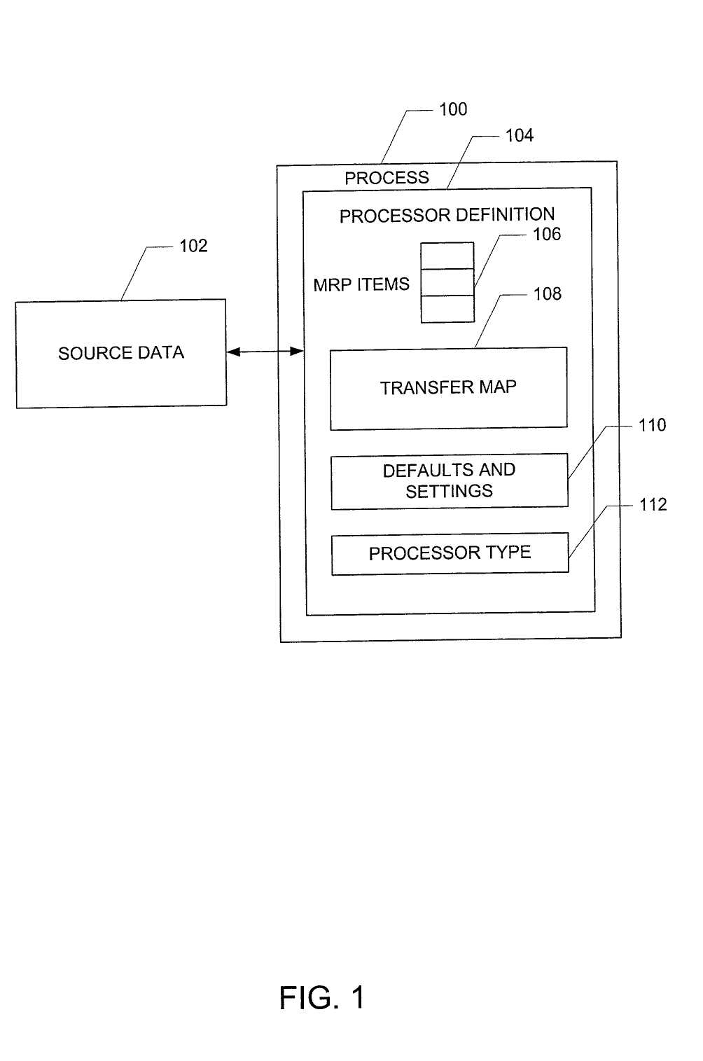

To more particularly describe the features of the present invention, please refer to FIGS. 1 through 8 in conjunction with the discussion below.

FIG. 1 illustrates a preferred embodiment of a system for manufacturing resource planning in accordance with the present invention. The MRP system includes a process 100 and source data 102. The process 100 is defined by a processor definition 104. The source data 102 comprise the externally input data. The processor definition 104 comprises a plurality of MRP items 106, a transfer map 108, defaults and settings 110, and a processor type 112. The MRP items reflect the source data 102 with edits specific to the configuration of the processor definition 104. The defaults and settings 110 store various values relevant to the configuration of the processor definition 104. The transfer map is for external data input processing, and indicates the location of values for particular fields in the MRP document or database records in the MRP parts catalog. The processor type 112 reflects how the MRP document or database record is to be produced by the processor definition 104. In the preferred embodiment, there are three processor types: manually generate, automatically generate, and automatically generated and send. Other processor types are possible.

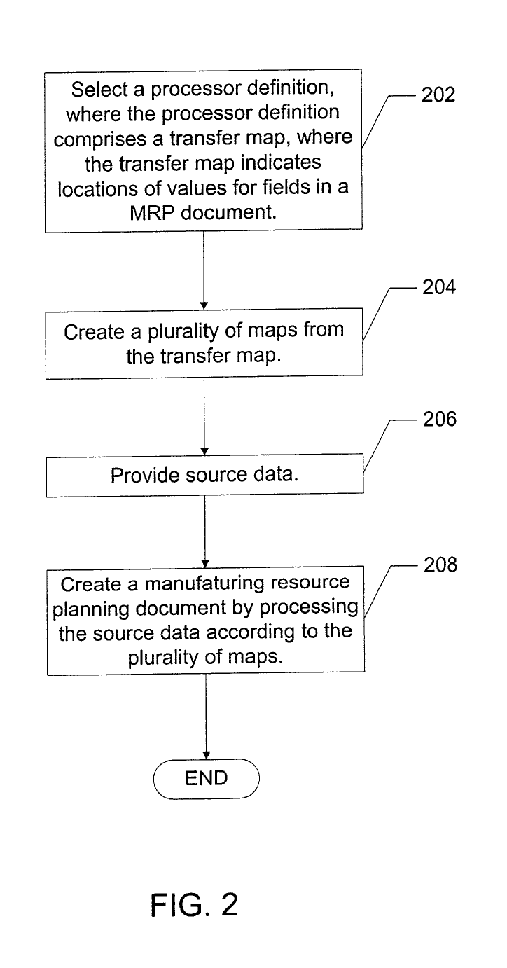

FIG. 2 is a flowchart illustrating a preferred embodiment of a method for manufacturing resource planning in accordance with the present invention. First, a processor definition 104 is selected, via step 202. As illustrated in FIG. 1, the processor definition 104 comprises a transfer map 108, where the transfer map 108 indicates the locations of values for particular fields in a MRP document or database records.

From the transfer map 108, a plurality of maps are created, via step 204. In the preferred embodiment, the plurality of maps comprise: (1) a required map, (2) a primary map, (3) an active map, (4) a default map, (5) a column map, and (6) a MRP item map.

The required map specifies the minimum required fields needed to complete the process, which is specific to each processor type. The required map is a static map.

The primary map stores non-required field names and their locations from the transfer map 108. Fields from the transfer map 108 that is not in the required map goes into the primary map.

The concatenation of the required and the primary maps form the active map. The active map is used for processing the lines in the MRP document. It guarantees that required fields are accounted for.

The default map stores the default fields and their values. This is determined by the transfer map 108 and the defaults and settings 110.

The column map stores the field names and column values specified in the transfer map 108.

The MRP item map stores the key MRP item's value and values for the other MRP items.

In the preferred embodiment, the primary map, the active map, the default map, the column map, and the MRP item map are created dynamically before data processing begins, i.e., created “on-the-fly”. Only the transfer map 108 is stored as part of the processor definition 104.

Next, the source data 102 are provided, via step 206. The MRP document or database records is then created by processing the source data 102 according to the plurality of maps, via step 208. In the preferred embodiment, the active map is a key map. It contains the fields which the user has indicated are to be used in the process 100 defined by the processor definition 104. For each line of the MRP document or database record, the process 100 loops through the active map to determine the fields to be processed and their values. For example, if a fieldname's value is “GLOBAL DEFAULT”, then the active map directs the process 100 to the default map to obtain its value. An example of a global default value is a billing address. If the fieldname's value is “DYNAMIC DEFAULT”, then the active map directs the process to make a callback to the processor to obtain its dynamic default value. An example of a dynamic default value is an automatically generated PO number. The PO number has a default value which changes with each PO created. If the fieldname's value is “COLUMN”, then the active map directs the process 100 to the column map for the index value of the fields read in from the source data 102 or some external process. If the fieldname's value is “MRP_ITEM”, then the active map directs the process 100 to the catalogue object in the MRP item map for the item currently being processed.

The method and system in accordance with the present invention provides several advantages. Since only the transfer map 108 is stored as part of the processor definition 104, the source data 102 may change without requiring changes to the processor definition 104 and vice versa. Because the plurality of maps are created on-the-fly, they also do not require changes when either the source data 102 or the processor definition 104 change. The processing in accordance with the active map is generic, thus the same processing code can be used for all MRP documents types (PO, Request For Quotation, etc.) and processor types (manually generate, automatically generate, automatically generate and send). Since only the values for the active fields are retrieved when the lines in the MRP document are processed, overhead is minimized, providing optimum performance for large batch processing. Significant validation can also be done prior to data processing, when the process is defined. Only validation of the actual field values remain when the data is processed. This increases performance for large batch processing. In this manner, the MRP method and system in accordance with the present invention is more flexible and efficient than conventional method and systems.

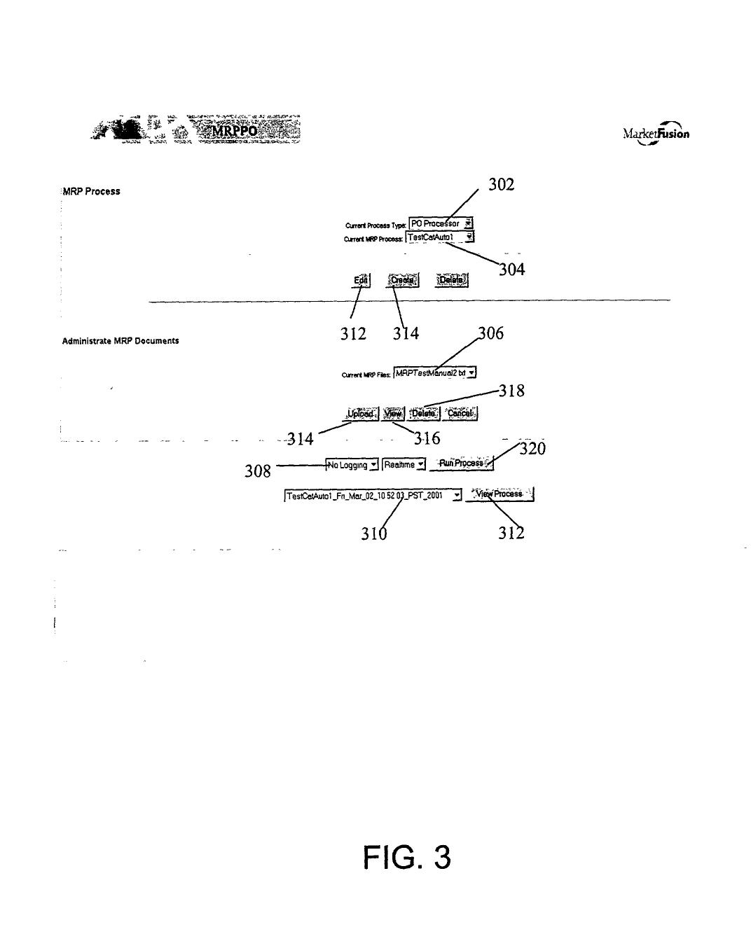

FIGS. 3 through 8 illustrate screen views for the creation of an example MRP document utilizing the method for manufacturing resource planning in accordance with the present invention. In this example, assume that a PO is to be created. FIG. 3 illustrates an example MRP administration view in accordance with the present invention. In this screen, a user can select/edit/create a process 100 and its processor definition 104, via step 202. For this example, the user selects the current process type, “PO Processor” 302, i.e., a PO is created as the MRP document. The user can then either select a current MRP process that has been created for the selected process type 302 or create a new one by activating the “Create” button 314. Assume that the user selects an existing process, “TestcatAuto1” 304. The selected current MRP process 304 has its own processor definition 104. The processor definition 104 comprises a corresponding transfer map 108, as described above.

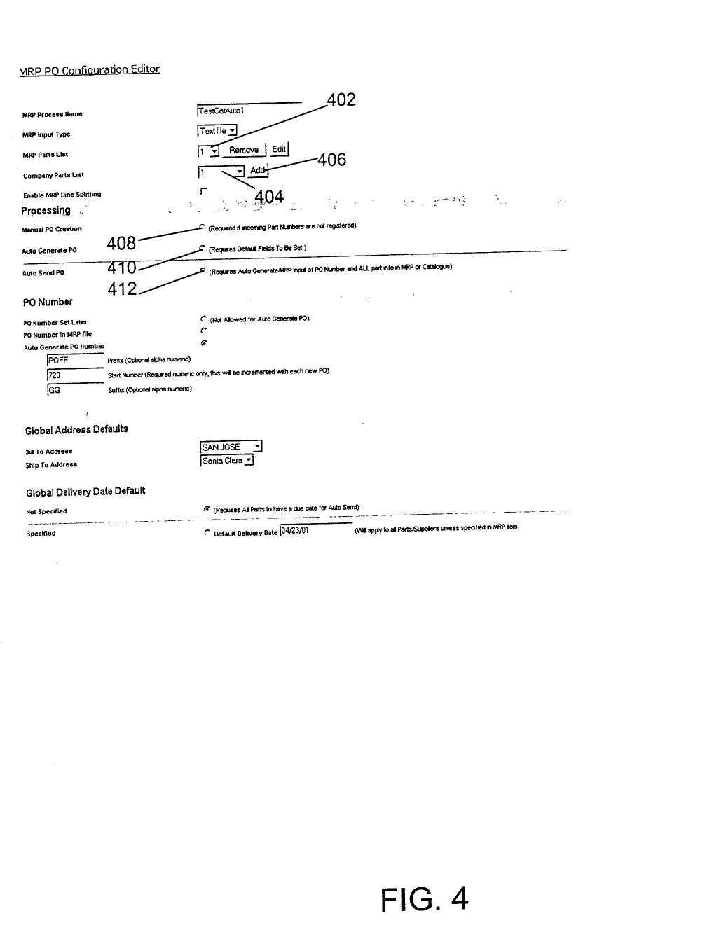

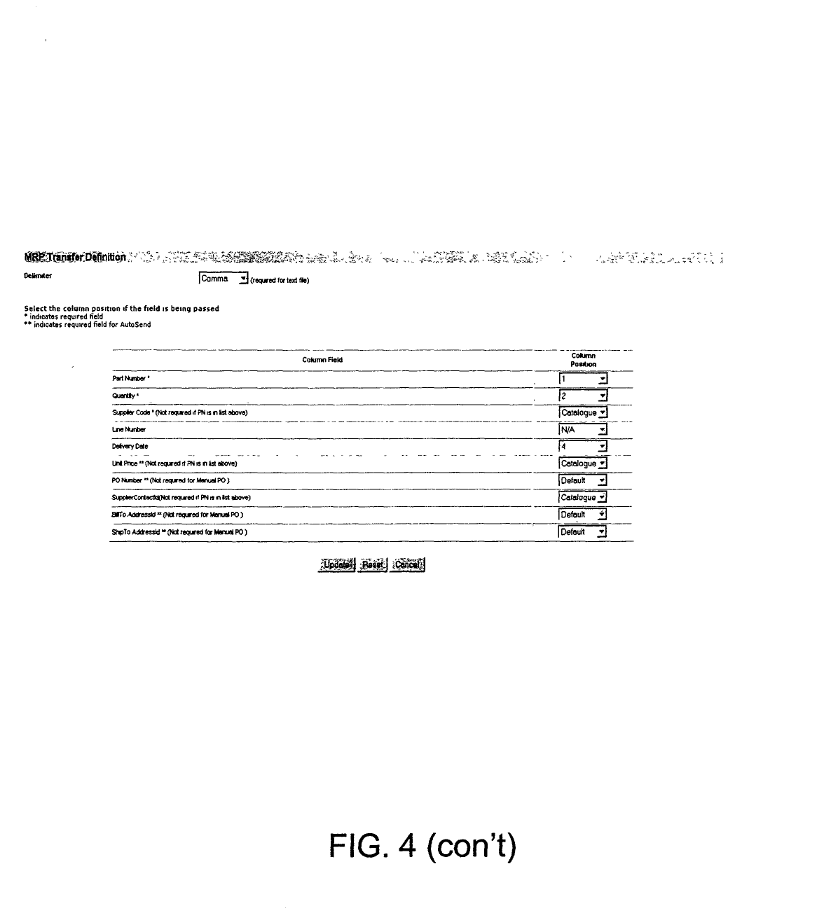

If the user activates the “Edit” 312 button on the MRP administration view, a MRP process configuration editor view is displayed. FIG. 4 illustrates an example MRP process configuration editor view in accordance with the present invention. The same view is displayed if the user activates the “Create” button 314 except the fields in the view have default values. The MRP parts list 402 and the company parts list 404 form the parts catalog. This parts catalog defines the MRP items 106 of the processor definition 104. The MRP items 106 here is the active subset of the MRP parts catalog. The list of MRP items 106 may be empty. This has three significant effects: (1) the processing is optimized when looking through the MRP parts catalog; (2) the processing may be done without using the MRP parts catalog; and (3) a mechanism is provided for local modification of the MRP parts catalog. The user may set the processor type 112. For example, the “TestCatAuto1” process can be set to manually generate the PO by selecting “Manual PO Creation” 408, automatically generate the PO by selecting “Auto Generate PO” 410, or automatically generate and send the PO by selecting “Auto Send PO” 412. The user can define the defaults and settings 110 by setting how the PO number is to be generated, the values of the global defaults, and the column positions for each field in the PO.

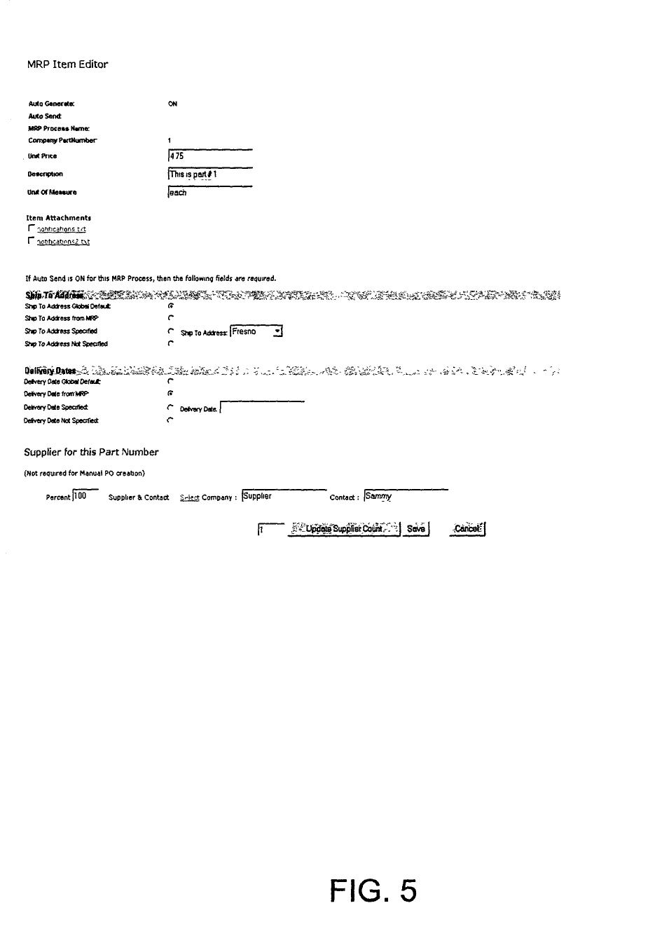

If the user activates the “Add” button 406 for the company parts list, a MRP parts editor view is displayed. FIG. 5 illustrates an example MRP parts editor view in accordance with the present invention. Using this view, the user may define or modify the information concerning the parts in the catalog and thus defines the MRP items 106.

Returning to the MRP administration view illustrated in FIG. 3, once the user selects the current process type 302 and the current MRP process 304, the user can select the source data 102, via step 206, by selecting the current MRP file. For example, the “MRPTestManual2.txt” file 306 is selected. The user can upload, view, and/or delete the current MRP file 306 by activating the “Upload” 314, “View” 316, or the “Delete” 318 buttons, respectively. When the “Upload” button 304 is activated, the source data 102 in “MRPTestManual2.txt” are input.

Also from the MRP administration view, the user can select various options 308 for the execution of the “TestCatAuto1” process, such as whether or not the execution will be logged. The MRP process can then be executed by activating the “Run Process” button 320. The plurality of maps are created from the transfer map 108 for the “TestCatAuto1” process, via step 204. The data input from “MRPTestManual2.txt” 306 is processed according to the plurality of maps from the transfer map 108 of the processor definition 104 for “TestCatAuto1”. The data from “MRPTestManaul2.txt” 306 is mapped to the line in the PO according to the plurality of maps to create the PO, via step 208.

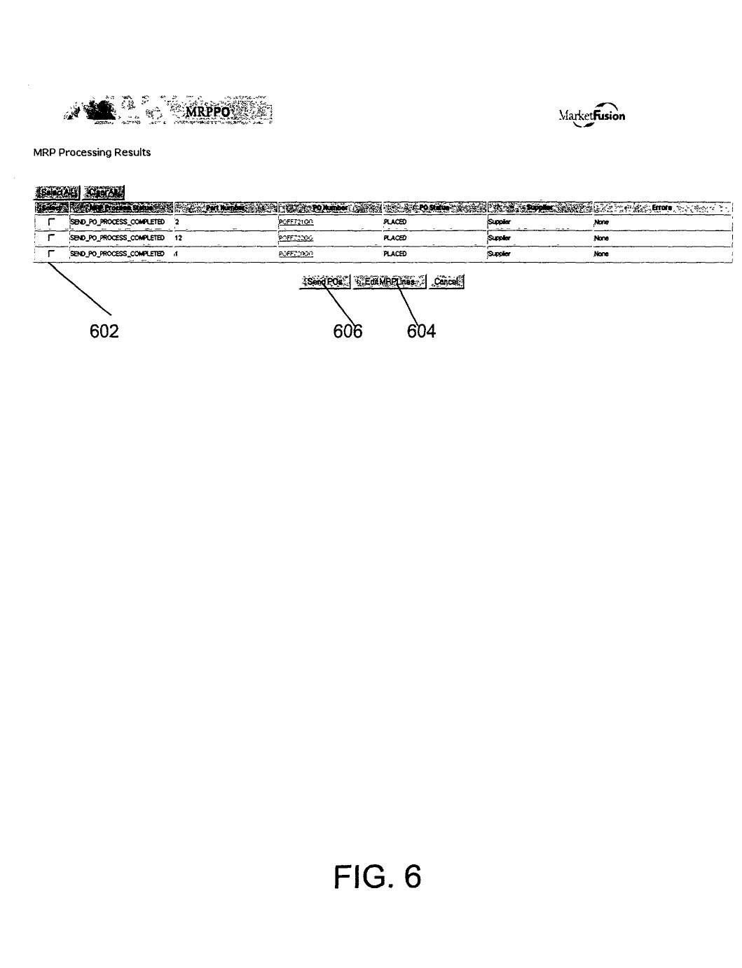

If the processor type 112 is set as manually generating the PO, then the results are displayed in a MRP Line Editor view. FIG. 6 illustrates an example MRP Line Editor view in accordance with the present invention. The MRP Line Editor view allows the user to edit particular lines of the PO by selecting the box(es) 602 in front of the line(s) and activating the “Edit MRPLines” button 604. The user can then send the PO by activating the “Send POs” button 606.

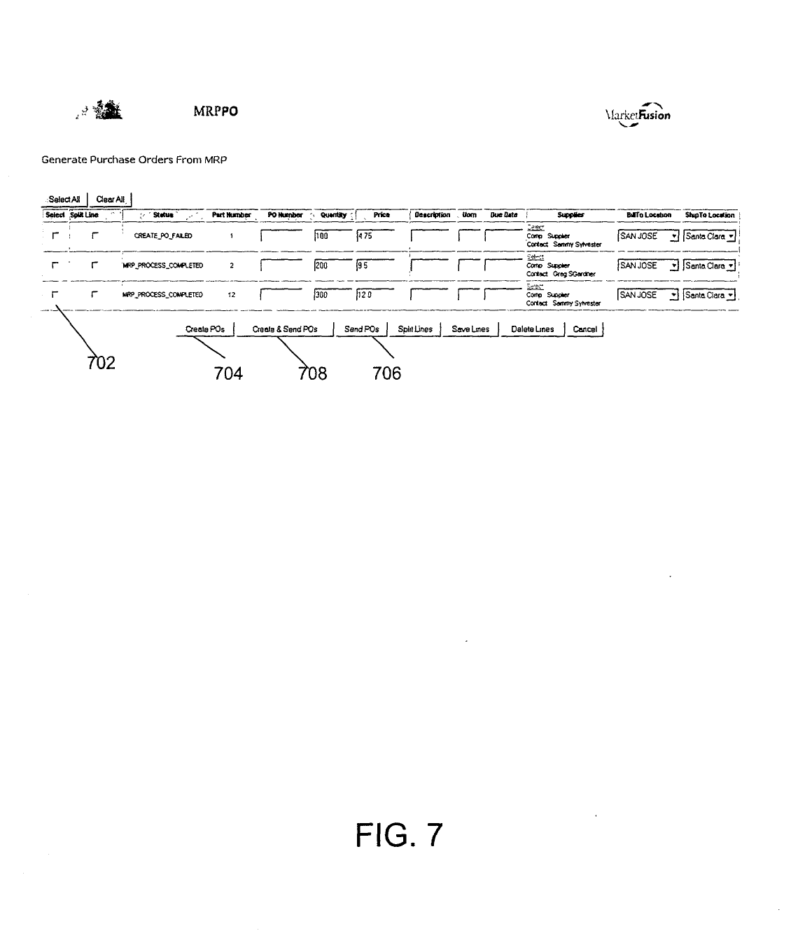

If the processor type 112 is set as automatically generating the PO or as automatically generating and sending the PO, then the results are displayed in a MRP PO Results view. FIG. 7 illustrates an example MRP PO Results view in accordance with the present invention. This view is also displayed if the user activates the “Send POs” button 606 in FIG. 6. From the MRP PO Results view, the user can select for which lines POs are to be created and/or sent. Other edits of the lines can be performed, such as the splitting of lines. The POs are sent when the user selects the box(es) 702 in front of the line(s) and activates the “Create POs” button 704 and then the “Send POs” button 706, or activates the “Create & Send POs” button 708.

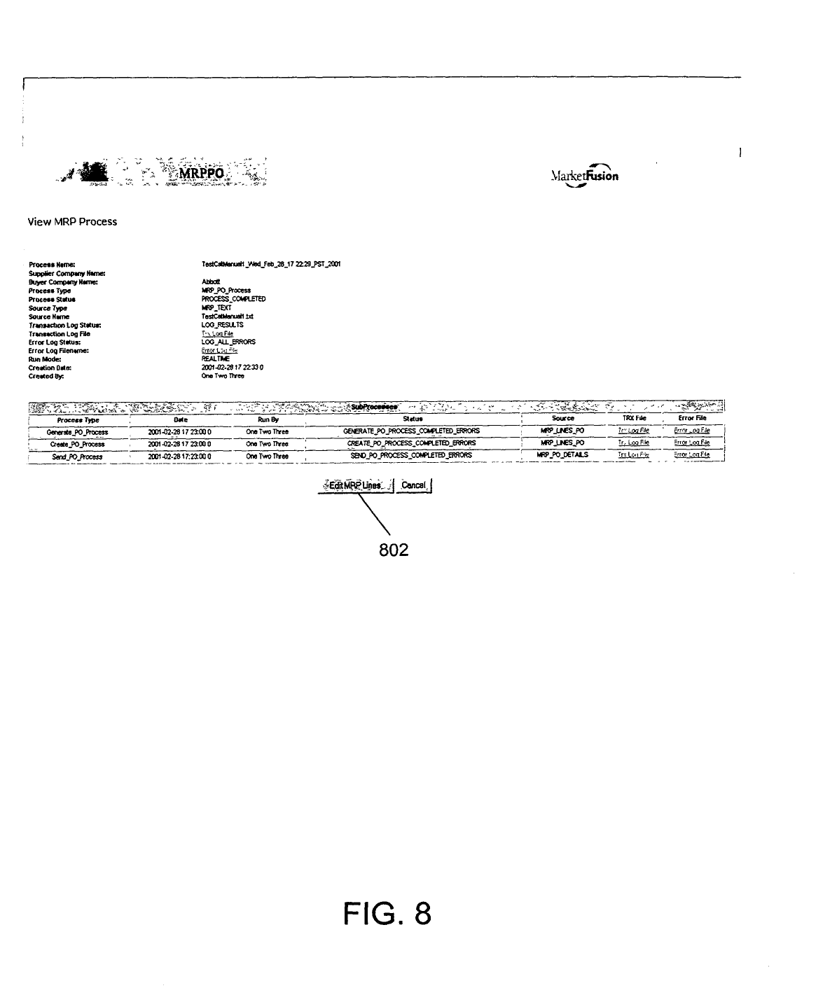

The results of the execution of the process are also stored in a file. In this example, the file is given a name comprised of a combination of the MRP process name and the date and time the process was run. Returning to FIG. 3, for example, the results are stored in the “TestCatAuto1_Fri_Mar_{—}02_{—}10:52:03_PST_{—}2001” file 310. The user can chose to view the details of the execution of “TestCatAuto1” by selecting this results file 310 and activating the “View Process” button 312. A View MRP Process view is then displayed. FIG. 8 illustrates an example View MRP Process view in accordance with the present invention. This view displays various information concerning the MRP process execution and the results. From this view, the user can access the transmission and/or the error log file. The user can also edit the MRP lines by activating the “Edit MRP Lines” button 802. The MRP Line Editor view, illustrated in FIG. 6, is then displayed.

A method and system for manufacturing resource planning (MRP) has been disclosed. The present invention provides a process defined by a processor definition. The processor definition defines the data configuration for a MRP document. The processor definition comprises MRP items, a transfer map, defaults and settings, and a processor type. Before processing of the source data, a plurality of maps are dynamically created from the transfer map. The source data are then configured according to the plurality of maps to create the MRP document or database records of the MRP parts catalog. Since only the transfer map is stored as part of the processor definition, the source data may change without requiring changes to the processor definition and vice versa. The present invention is more flexible and efficient than conventional method and systems.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for manufacturing resource planning (MRP), comprising the steps of:
(a) selecting a processor definition, wherein the processor definition comprises a transfer map, wherein the transfer map indicates locations of values for one or more fields in a MRP document or in a database record in a MRP parts catalog;
(b) creating a plurality of maps from the transfer map;
(c) providing source data; and
(d) creating the MRP document or the database record by processing the source data according to the plurality of maps.

2. The method of claim 1, wherein the processor definition further comprises:
MRP items, wherein the MRP items reflect the source data with edits specific to a configuration of the processor definition.

3. The method of claim 1, wherein the processor definition further comprises:
defaults and settings, wherein the defaults and settings store various values relevant to a configuration of the processor definition.

4. The method of claim 1, wherein the processor definition further comprises:
a processor type, wherein the processor type reflects how the MRP documents or the database record is to be produced by the processor definition.

5. The method of claim 1, wherein the MRP document comprises a purchase order.

6. The method of claim 1, wherein the MRP document comprises a request for quotation.

7. The method of claim 1, wherein the creating step (b) comprises:
(b1) creating the plurality of maps dynamically from the transfer map before processing of the source data.

8. The method of claim 1, wherein the plurality of maps comprises:
a required map, wherein the required map includes minimum required fields needed to complete a process defined by the processor definition.

9. The method of claim 1, wherein the plurality of maps comprises:
a primary map, wherein the primary map stores non-required field names and locations for the non-required field names from the transfer map.

10. The method of claim 1, wherein the plurality of maps comprises:
an active map, wherein the active map is a concatenation of a required map and a primary map, wherein the active map is used for processing lines in the MRP document.

11. The method of claim 1, wherein the plurality of maps comprises:
a default map, wherein the default map stores default fields in the MRP document or the database record and values for the default fields.

12. The method of claim 1, wherein the plurality of maps comprises:
a column map, wherein the column map stores field names and column values from the transfer map.

13. The method of claim 1, wherein the plurality of maps comprises:
a MRP item map, wherein the MRP item map stores a value for a key MRP item and values for MRP items.

14. A system, comprising:
source data; and
a processor definition, wherein the processor definition comprises a transfer map, wherein the transfer map indicates locations of values for one or more fields in a MRP document or a database record in a MRP parts catalog.

15. The system of claim 14, wherein the processor definition further comprises:
MRP items, wherein the MRP items reflect the source data with edits specific to a configuration of the processor definition.

16. The system of claim 14, wherein the processor definition further comprises:
defaults and settings, wherein the defaults and settings store various values relevant to a configuration of the processor definition.

17. The system of claim 14, wherein the processor definition further comprises:
a processor type, wherein the processor type reflects how the MRP documents is to be produced by the processor definition.

18. The system of claim 14, wherein a plurality of maps are created dynamically from the transfer map before processing of the source data.

19. The system of claim 18, wherein the plurality of maps comprises:
a required map, wherein the required map includes minimum required fields needed to complete a process defined by the processor definition.

20. The system of claim 18, wherein the plurality of maps comprises:
a primary map, wherein the primary map stores non-required field names and locations for the non-required field names from the transfer map.

21. The system of claim 18, wherein the plurality of maps comprises:
an active map, wherein the active map is a concatenation of a required map and a primary map, wherein the active map is used for processing lines in the MRP document.

22. The system of claim 18, wherein the plurality of maps comprises:
a default map, wherein the default map stores default fields in the MRP document and values for the default fields.

23. The system of claim 18, wherein the plurality of maps comprises:
a column map, wherein the column map stores field names and column values from the transfer map.

24. The system of claim 18, wherein the plurality of maps comprises:
a MRP item map, wherein the MRP item map stores a value for a key MRP item and values for MRP items.

25. The system of claim 14, wherein the MRP document comprises a purchase order.

26. The system of claim 14, wherein the MRP document comprises a request for quotation.

27. A computer readable medium with program instructions for MRP, comprising the instructions for:
(a) selecting a processor definition, wherein the processor definition comprises a transfer map, wherein the transfer map indicates locations of values for one or more fields in a MRP document or in a database record of a MRP parts catalog;
(b) creating a plurality of maps from the transfer map;
(c) providing source data; and
(d) creating the MRP document or the database record by processing the source data according to the plurality of maps.

28. The medium of claim 27, wherein the processor definition further comprises:
MRP items, wherein the MRP items reflect the source data with edits specific to a configuration of the processor definition.

29. The medium of claim 27, wherein the processor definition further comprises:
defaults and settings, wherein the defaults and settings store various values relevant to a configuration of the processor definition.

30. The medium of claim 27, wherein the processor definition further comprises:
a processor type, wherein the processor type reflects how the MRP documents is to be produced by the processor definition.

31. The medium of claim 27, wherein the MRP document comprises a purchase order.

32. The medium of claim 27, wherein the MRP document comprises a request for quotation.

33. The medium of claim 27, wherein the creating instruction (b) comprises instructions for:
(b1) creating the plurality of maps dynamically from the transfer map before processing of the source data.

34. The medium of claim 27, wherein the plurality of maps comprises:
a required map, wherein the required map includes minimum required fields needed to complete a process defined by the processor definition.

35. The medium of claim 27, wherein the plurality of maps comprises:
a primary map, wherein the primary map stores non-required field names and locations for the non-required field names from the transfer map.

36. The medium of claim 27, wherein the plurality of maps comprises:
an active map, wherein the active map is a concatenation of a required map and a primary map, wherein the active map is used for processing lines in the MRP document.

37. The medium of claim 27, wherein the plurality of maps comprises:
a default map, wherein the default map stores default fields in the MRP document or the database record and values for the default fields.

38. The medium of claim 27, wherein the plurality of maps comprises:
a column map, wherein the column map stores field names and column values from the transfer map.

39. The medium of claim 27, wherein the plurality of maps comprises:
a MRP item map, wherein the MRP item map stores a value for a key MRP item and values for MRP items.
